(19) United States
(12) Patent Application Publication
(10) Pub. No.: US 2007/0141239 A1
(43) Pub. Date: Jun. 21, 2007

(54) MAGNETIC RECORDING MEDIUM AND METHOD OF FABRICATING THE SAME

(76) Inventor: Yasumi Sato, Miyagi (JP)

Correspondence Address: David R. Metzger;SONNENSCHEIN NATH & ROSENTHAL, Sears Tower, Wacker Drive Station, P.O. Box 061080, Chicago, IL, 60606-1080, US

(21) Appl. No.: 11/668,650

(22) Filed: Jan. 30, 2007

Related U.S. Application Data
(62) Division of application No. 10/910,225, filed on Aug. 3, 2004.

(30) Foreign Application Priority Data
Aug. 8, 2003 (JP) P2003-289576

(51) Int. Cl. B05D 5/12; B05D 3/00

(52) U.S. Cl. 427/128; 427/294

(57) ABSTRACT

In order to attain a magnetic recording medium compliant with the AIT4 format and capable of accomplishing a block error rate of 1×10⁻⁴ or below, there is provided a magnetic recording medium having a magnetic layer composed of a metal magnetic thin film formed on a non-magnetic substrate composed of an aromatic polyamide film, in which the magnetic layer has a coercive force Hc of 120 kA/m to 235 kA/m, and a square ratio Rs of 0.69 or above.

### CROSS REFERENCES TO RELATED APPLICATIONS

This application is a divisional of U.S. patent application Ser. No. 10/910,225, filed Aug. 3, 2004, the entirety of which is incorporated herein by reference to the extent permitted by law. The present application claims priority to Japanese Patent Application No. JP 2003-289576, filed in the Japanese Patent Office on Aug. 8, 2003, the entire contents of which being incorporated herein to the extent permitted by law.

### BACKGROUND OF THE INVENTION

1. Field of the Invention

The present invention relates to a large-capacity magnetic tape used as a storage medium, especially as an external storage medium, for office computers such as minicomputers or personal computers, and computers in other various applications, and a method of fabricating the same.

2. Description of Related Art

With recent dissemination of office computers such as minicomputers and personal computers, a magnetic tape, as an external storage medium, for recording computer data, which is a so-called tape streamer is extensively investigated. In view of bringing the magnetic tape for these applications into practical use, there are increasing demands on improvement in the recording capacity in order to achieve larger recording capacity and down-sizing, in particular with increasing trends of down-sizing and enhancement in information processing ability of computers.

There are increasing demands also on reliability in the use and data storage under a wide variety of use environments, in particular under heavily-fluctuating temperature conditions and humidity conditions, which has arisen from expansion of use environment of the magnetic tape, and on reliability of performances such as stable data recording and reading under repetitive use under high-speed multiple running.

The magnetic tape is generally configured so that a magnetic layer is disposed on a non-magnetic substrate composed of a flexible material such as a synthetic resin. In order to achieve a large recording capacity (volume recording capacity) of this sort of magnetic tape, a method which is believed to be effective is such as forming a magnetic layer which comprises a ferromagnetic metal thin film to thereby increase recording density of the magnetic layer per se, and thinning the total thickness of the magnetic tape. That is, a so-called metal evaporated tape having a metal magnetic thin film formed on the non-magnetic substrate is preferable.

As the non-magnetic substrate of the metal evaporated tape having the metal magnetic thin film formed thereon, polyester, which is mainly a polyethylene terephthalate film, is generally adopted. For example, a polyethylene terephthalate film of approximately 7 to 10 μm thick is used for a home video cassette tape such as an 8-mm tape, and a polyethylene terephthalate film of approximately 5 to 7 μm thick is used for a tape streamer used for back-up of computer data. As one method for elongating recording time of magnetic recording medium used for video tapes, it is known to be preferable to use, as the non-magnetic substrate, a material mainly composed of polyester, which is typified by polyethylene naphthalate (see Patent Document 1, for example).

There is another investigation on use, as the non-magnetic substrate, of a polyamide film which is larger in strength as compared with the polyethylene terephthalate or polyethylene naphthalate film. The polyamide film can be reduced in thickness by virtue of its large strength, and attracts a public attention as a magnetic recording medium adapted to longer recording time of video cassette tapes and larger capacity of tape streamers.

Also there is a demand for the tape streamer to increase the capacity under recent increase in information volume, wherein strong demands reside in improvement in the magnetic recording density, that is, shortening of the recording wavelength, and narrowing of track pitch. Both of the shortening of the recording wavelength and narrowing of the track pitch, however, result in lowering in the output and S/N ratio, so that this further demands improved performance of magnetic heads, increased output of the magnetic tape, and a higher S/N ratio.

Meanwhile, one known major standard for tape storage is AIT (advanced intelligent tape), which is a format for tape streamer using an 8-mm-wide metal evaporated tape as a recording medium. In connection to this standard, there is proposed AIT4 (200 GB/reel) as a next-generation format capable of realizing a more larger capacity as compared with the conventional AIT3 (100 GB/reel). The AIT4 format realizes doubled capacity by narrowing the track pitch as compared with the conventional one, shortening the recording wavelength, and adopting an anisotropic magneto resistive head (referred to as AMR head, hereinafter) or giant magneto resistive head (referred to as GMR head, hereinafter), having a sensitivity higher than that of a conventional induction-type reproduction magnetic head, but this consequently puts demand on tapes having a higher S/N ratio (signal-noise ratio).

In a film formation process of large-capacity magnetic tapes, an evaporated film composed of a ferromagnetic metal such as Co or its alloy is formed. In such a process, one known method for addressing the above-described increase in the output is such as introducing oxygen in the metal evaporation process. A continuous-windup-type vacuum evaporation apparatus 10 as exemplified in FIG. 1 can be used for the evaporation process of this kind of ferromagnetic metal or its alloy. In FIG. 1, a non-magnetic substrate 1 is fed from an unwinding roll 2, allowed to travel on a circumferential surface of a cooling can 6, and taken up by a winding roll 7. Under the presence of a trace amount of oxygen fed through an oxygen introducing pipe 4, a metal irradiated by electron beam from an electron gun 8, and the metal magnetic material 3 deposits on a surface of the non-magnetic substrate 1 to thereby form a metal magnetic thin film.

The above-described introduction of oxygen in the film formation process allows micronization of Co crystals to be grown in the evaporation process, promotes magnetic separation of the Co crystal by virtue of Co—O, improves a residual magnetic flux density, and realizes higher output and lower noise.

For the case where the metal magnetic thin film is formed under the oxygen introduction as described in the above, an extremely small amount of introduced oxygen may raise a problem in that the micronization of the crystal cannot proceed, and this results in lowered output of the magnetic layer composed of the metal magnetic thin film, and increased noise. On the other hand, too much introduced oxygen may be successful in proceeding the micronization and thereby reducing the noise, and in reducing self demagnetization and recording demagnetization in short-wavelength region and thereby obtaining high output by virtue of increased coercive force Hc, but the increase in the output shows a maximum value, which means limitation in increasing the output. Introduction of oxygen in an amount not lower than the amount of oxygen corresponded to the maximum output value so as to raise the coercive force Hc adversely lowers the residual magnetization Mr, and considerably degrades the output in long-wavelength region. As a consequence, this raises a problem of lowering in S/N ratio as viewed over the entire frequency range to be used.

The introduced oxygen also results in formation of a oxide film on the surface of the magnetic layer, which is formed thinner as the amount of introduction of oxygen decreases, and ensures larger output in the short wavelength region. A small amount of oxygen, however, cannot fully proceed the micronization of the evaporated metal magnetic material, only results in lowered output in the short-wavelength region and in extremely increased noise, and this consequently results in a lowered S/N ratio.

It is thus considered that it is made possible to fabricate a magnetic film having an increased residual magnetic flux density and also having a thin surface oxide film formed thereon, if the micronization of Co can be proceeded in a region of coercive force Hc slightly lower than the conventional one, and it is also made possible to fabricate a magnetic recording medium having higher output and lower noise, which mean a lower S/N ratio, than those of the conventional one.

As has been described in the above, a problem which resides in the magnetic tape fabricated by forming the metal magnetic thin film on the non-magnetic substrate under introduction of oxygen is to make balance between characteristics relevant to coercive force Hc and residual magnetization Mr, and to achieve high S/N and large output.

[Patent Document]

Japanese Patent Application Publication (KOKAI) No. Hei 6-215350

### SUMMARY OF THE INVENTION

The present invention was conceived considering the aforementioned situation, and an object thereof is to realize a high S/N ratio by promoting micronization of the metal crystals through high-speed evaporation, and by reducing spacing loss through reduction in the degree of oxidation of the magnetic layer to thereby reduce the thickness of the surface oxide film.

A magnetic recording medium of the present invention is configured so that a magnetic layer composed of a metal magnetic thin film is formed on a non-magnetic substrate composed of an aromatic polyamide film. In the magnetic recording medium, the magnetic layer has a coercive force Hc of 120 kA/m to 235 kA/m, and a square ratio Rs of 0.69 or above.

A method of fabricating a magnetic recording medium of the present invention comprises a step of allowing a non-magnetic substrate to continuously travel and forming a magnetic layer by the vacuum evaporation process under introduction of oxygen gas. In the method, the travel speed of the non-magnetic substrate is adjusted to 130 m/min to 230 m/min, the coercive force Hc of the magnetic layer is adjusted to 120 kA/m to 235 kA/m, and the square ratio Rs is adjusted to 0.69 or above.

According to the present invention, the degree of film oxidation can be suppressed by setting the travel speed of the non-magnetic substrate in the magnetic layer forming process faster than in the conventional method. Because the surface oxide film on the magnetic layer is thinned, block error rate is also reduced.

According to the present invention, it is possible to achieve a block error rate (1×10⁻⁴ or below) required for the AIT4 format for an extremely high recording density, by controlling the degree of film oxidation in the vacuum evaporation process of the magnetic layer, and by specifying coercive force Hc to 120 kA/m to 235 kA/m, and square ratio to 0.69 or above.

According to the present invention, it is also possible to obtain a magnetic recording medium capable of achieving a block error rate (1×10⁻⁴ or below) required for the AIT4 format for an extremely high recording density, by improving square ratio Rs, which is particularly specified to 0.69 or above, by controlling coercive force Hc to 120 kA/m to 235 kA/m, through raising the travel speed in the magnetic layer forming process than in the conventional method (80 m/min), in particular set to 130 m/min to 230 m/min, while leaving the thickness of the magnetic layer remained equivalent to the conventional one, to thereby lower the degree of oxidation of the magnetic layer than the conventional one.

According to the present invention, it is possible to provide a magnetic recording medium adapted to the AIT4 format (200 GB/reel) which is a major standard for the next-generation tape storage, having a doubled recording capacity of the conventional AIT3 format (100 GB/reel).

### BRIEF DESCRIPTION OF THE DRAWINGS

The above and other objects, features and advantages of the present invention will become more apparent from the following description of the presently preferred exemplary embodiments of the invention taken in conjunction with the accompanying drawings, in which:

FIG. 1 is a schematic configuration drawing of a vacuum evaporation apparatus for forming a magnetic layer;

FIG. 2 is a schematic sectional view of a magnetic recording medium;

FIG. 3 is a flow chart of process steps for fabricating the magnetic recording medium;

FIG. 4 is a schematic view showing a configuration of a CVD apparatus for forming a protective layer;

FIG. 5 is a schematic view showing a configuration of a hot rolling apparatus for correcting warping of a magnetic tape;

FIG. 6 shows relations between coercive force Hc and block error rate of sample magnetic tapes; and

FIG. 7 shows relations between coercive force Hc and square ratio Rs of the sample magnetic tapes.

### DESCRIPTION OF PREFERRED EMBODIMENTS

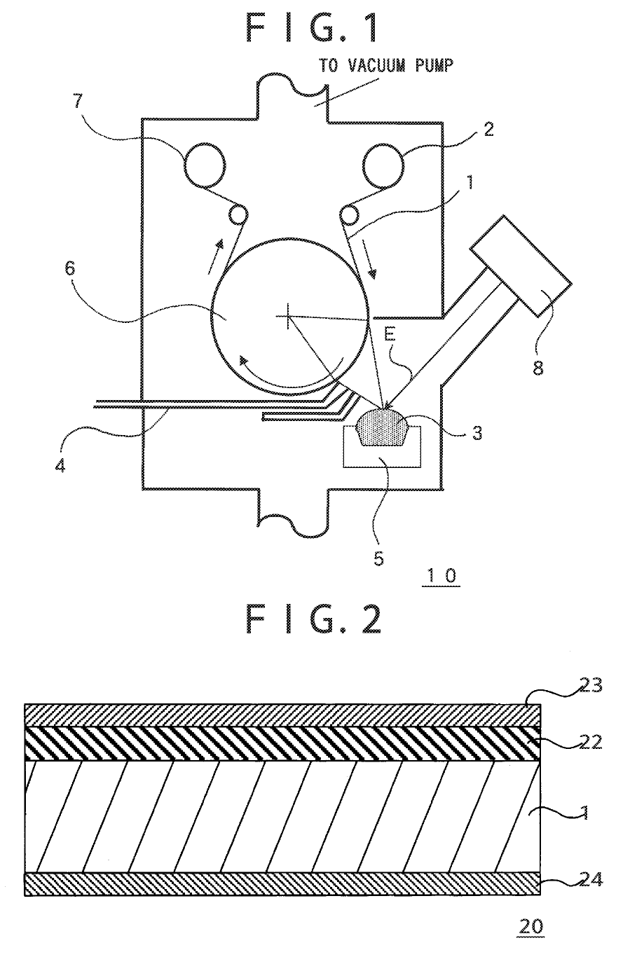

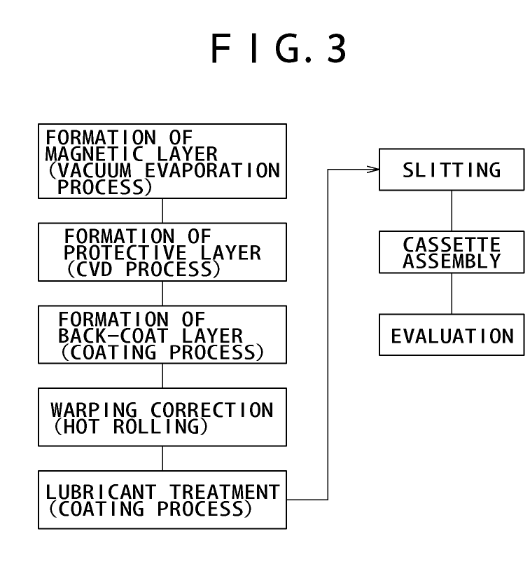

Specific embodiments of a magnetic recording medium of the present invention will be described, however, it is to be noted that the present invention is by no means limited to the examples below. The present invention will be explained showing an exemplary configuration of a magnetic recording medium 20 in FIG. 2, and a flow chart of an outlined fabrication process of the magnetic recording medium in FIG. 3.

As shown in FIG. 2, the magnetic recording medium 20 is configured so that a magnetic layer 22 composed of a metal magnetic thin film and a protective layer 23 are formed on one main surface of a non-magnetic substrate 1, and a back-coat layer 24 is formed on the other main surface of the non-magnetic substrate 1. It is to be noted that the magnetic recording medium of the present invention is adapted to AIT4 (recording capacity 200 GB/reel) in AIT, one of major standards of tape storage, to which an MR head or GMR head can be applied as a reproducing magnetic head.

The non-magnetic substrate 1 of the magnetic recording medium is assumed herein to be composed of an aromatic polyamide film. The aromatic polyamide film makes it possible to thin the magnetic recording medium, and is suitable for addressing increase in capacity of the tape streamer by virtue of its larger strength as compared with that of a general-purpose plastic films such as polyethylene terephthalate.

A flow chart of a fabrication process of the magnetic recording medium 20 is shown in FIG. 3. First, an evaporated film was formed on one main surface of a polyamide film (product of TORAY Industries, Inc.) by the high-rate vacuum evaporation process described later, and on the evaporated film, a carbon protective layer was formed by the CVD process. Next, a back-coat layer was formed by coating on the main surface opposite to the magnetic-layer-formed surface. Hot-rolling was then carried out to correct any warping, and a lubricant was coated on the surface of the protective layer. Thus-fabricated magnetic tape was slit in an 8-mm width, subjected to measurement of magnetic properties by VSM (Vibrating Sample Magnetometer), and to measurement and evaluation of block error rate on a prototype AIT4 apparatus. The individual process steps will be detailed below.

[Formation of Magnetic Layer]

In a process of forming the magnetic layer 22 on the non-magnetic substrate 1 while allowing it to continuously travel, applied with the vacuum evaporation process in which a ferromagnetic metal is deposited under introduction of oxygen gas, it was aimed that the travel speed of the non-magnetic substrate 1 is controlled within an appropriate range, which was specified to 130 m/min to 230 m/min.

A film forming process of the magnetic layer 22 will be explained, exemplifying a case where the vacuum evaporation is carried out using the continuous-windup-type vacuum evaporation apparatus 10 shown in FIG. 1. The non-magnetic substrate 1 is fed from the unwinding roll 2, allowed to travel on the circumferential surface of the cooling can 6, and continuously taken up by the winding roll 7. During the continuous travel, the metal magnetic material 3, which is Co, for example, is heated by electrons E emitted from the electron gun 8, and adheres on the non-magnetic substrate 1, to thereby form the magnetic layer 22. The magnetic layer 22 is appropriately oxidized, during the formation thereof, by oxygen introduced through the oxygen introducing pipe 4, and thereby the magnetic metal crystal (Co crystal) is micronized.

During the vacuum evaporation, the inner space of the continuous-windup-type vacuum evaporation apparatus 10 was evacuated to a degree of vacuum of approximately 10⁻³ Pa using a vacuum pump. The metal magnetic film composed of Co was then formed by the continuous oblique-angled vacuum evaporation process. The incident angle of the evaporated material was adjusted to 80° to 45° away from the normal line of the non-magnetic substrate 1. The non-magnetic substrate 1 was allowed to travel on the circumferential surface of the cooling can 6 which was cooled to −40° C., the travel speed and the amount of introduced oxygen were controlled, and the intensity of the electron beam was also controlled by adjusting electric power applied to the electron gun 8 so as to constantly keep the thickness of the magnetic metal thin film to 50 nm, for example.

The formation of the metal magnetic thin film having the same thickness with that of the conventional metal evaporated tape by adjusting the travel speed of the non-magnetic substrate 1 faster than that in the conventional fabrication process of the metal evaporated tape (80 m/min) and by increasing the electron beam output through increase in electric power applied to the electron gun 8 in the evaporation process, it is made possible to promote the micronization of the Co crystals than in the magnetic layer formed by the conventional method, and to obtain a higher S/N ratio at the same wavelength. In other words, the magnetic recording medium of the present invention can be obtained by so-called “high-rate evaporation process”, which is a method of obtaining a high output of the magnetic layer by allowing the evaporation to proceed at a higher rate than in the conventional method, and by suppressing the degree of oxidation of the film.

In the formation process of the magnetic layer, the travel speed of the non-magnetic substrate 1 was specifically set to 130 m/min to 230 m/min, so as to adjust the coercive force Hc of the magnetic layer to 120 kA/m to 235 kA/m, and the square ratio Rs to 0.69 or above.

[Formation of Protective Layer]

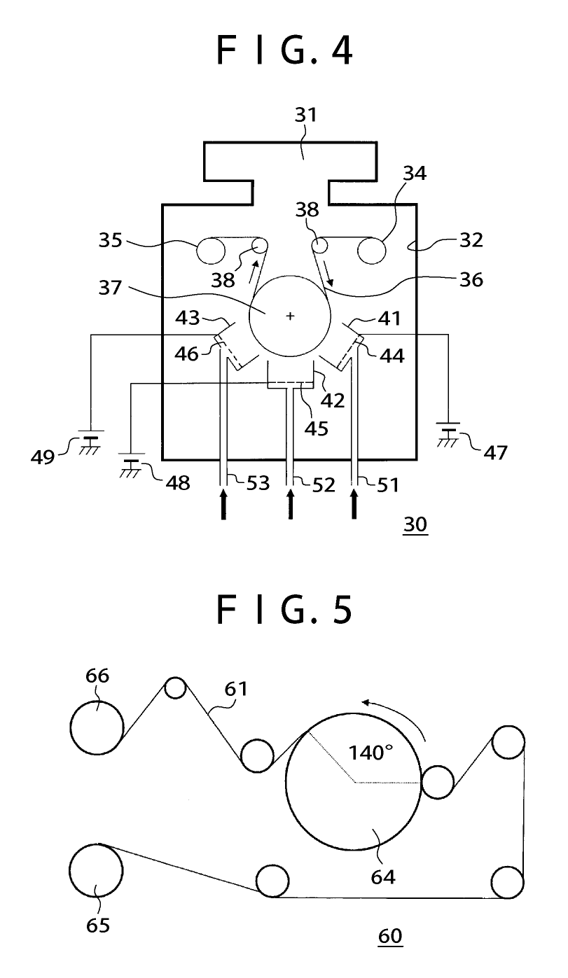

Next, using a CVD apparatus 30 shown in FIG. 4, the protective layer 23 composed of a carbon film was formed to a thickness of 10 nm on the material-to-be-processed having the magnetic layer 22 formed thereon, using ethylene gas (C₂H₄) as a source material under a gas atmosphere conditioned to have a mixing ratio of ethylene and argon gases of 4:1. The CVD process, by which a source gas is decomposed in plasma to proceed film formation, makes it possible to form a diamond-like carbon film, which is excellent in abrasion resistance, corrosion resistance and surface coverage, and has a smooth surface morphology and a high electric resistivity, to an extremely small thickness in a stable manner. The hydrocarbon gas as the source gas may be used in a form of simple substance or in a composite material, and may be introduced with a non-hydrocarbon gas such as Ar, N₂ or the like as a gas for promoting decomposition of the carbon compound during the plasma generation.

The CVD apparatus 30 shown in FIG. 4 is configured so that an unwinding roll 34 and a winding roll 35 are disposed in a vacuum chamber 32 kept in a near-vacuum state after being evacuated through an evacuation system 31, and so that a material-to-be-processed 36 is allowed to continuously travel between the unwinding roll 34 and winding roll 35. On a mid-course of travel of the material-to-be-processed 36 from the unwinding roll 34 towards the winding roll 35, a cylindrical, rotatable opposing electrode can 37 is disposed.

The material-to-be-processed 36 is continuously fed from the unwinding roll 34, allowed to pass the circumferential surface of the opposing electrode can 37, and wound around the winding roll 35. Guide rolls 38 are disposed respectively between the unwinding roll 34 and the opposing electrode can 37, and between the opposing electrode can 37 and the winding roll 35, so as to apply a predetermined tension to the material-to-be-processed 36, and to allow the material-to-be-processed 36 to smoothly travel.

There are also disposed reaction tubes 41 to 43 typically composed of Pyrex (registered trademark) glass, plastic or the like, so as to oppose with the opposing electrode can 37. The reaction tubes 41 to 43 are configured to have film forming gas introduced therein through gas introduction ports 51 to 53 respectively connected thereto. The reaction tubes 41 to 43 also have planar discharge electrodes 44 to 46 fabricated therein. The discharge electrodes 44 to 46 are configured so as to be applied with potential of 500 to 2,000 V, for example, from externally disposed DC power sources 47 to 49.

In thus configured CVD apparatus 30, application of voltage to the discharge electrodes 44 to 46 activates a plasma between the discharge electrodes 44 to 46 and opposing electrode can 37. The film forming gases introduced into the reaction tubes 41 to 43 cause decomposition and chemical binding with the aid of the generated plasma energy, deposition on the material-to-be-processed 36, and thereby the protective layer 23 is formed.

[Formation of Back-Coat Layer]

Next, the back-coat layer 24 is formed on the main surface opposite to the formation surface of the magnetic layer 22. A back-coat paint is prepared by mixing, for example, carbon black, polyester polyurethane and an organic solvent, and the product is coated on the non-magnetic substrate on the surface opposite to that having the magnetic metal film formed thereon, to thereby form the back-coat layer 24.

[Warping Correction (Hot Rolling)]

After the back-coat layer 24 is formed, annealing for correcting warping (cupping) of the tape, that is hot rolling, is carried out using a hot rolling apparatus 60 of which schematic configuration is shown in FIG. 5. In FIG. 5, a heat roll 64 is a metal cylindrical roll of approximately 250 mm in diameter, having heating means such as an induction heating coil or the like incorporated therein, and is arranged so as to freely control the surface temperature thereof within a predetermined temperature range. The temperature range herein is controlled in a range from 100° C. to 300° C. or around. A material-to-be-processed 61 supplied from an unwinding roll 65 is allowed to travel so as to bring the magnetic layer forming surface side into contact with the surface of the rotating heat roll 64, corrected in the warping, and then wound around a winding roll 66.

[Lubricant Coating Process]

After the warping correction, perfluoropolyether as a lubricant was coated on the protective layer 23 to a thickness of approximately 10 nm. This ensures travel performance, abrasion resistance, durability and so forth.

According to the processes described in the above, a master roll of the tape having the magnetic layer 22 and protective layer 23 formed on one main surface of the non-magnetic substrate 1 and having the back-coat layer 24 on the other main surface is fabricated. The master roll of the tape is slit into an 8-mm width to thereby obtain the magnetic tape. The tape is housed in an AIT cassette body to thereby obtain an AIT cassette tape.

### EXAMPLES

The following paragraphs will describe specific experimental results with respect to Examples and Comparative Examples of the magnetic recording medium of the present invention, wherein the present invention is by no means limited to the Examples described below.

### Examples 1 to 11, Comparative Examples 1 to 11

The magnetic recording medium having the layer configuration shown in FIG. 2 was fabricated according to a fabrication process flow shown in FIG. 3. A polyamide film, product of TORAY Industries, Inc. of 1 m wide and 10,000 m long was used as the non-magnetic substrate 1, and set on the continuous-windup-type vacuum evaporation apparatus as shown in FIG. 1. The inner space of the vacuum evaporation apparatus 10 was evacuated to a degree of vacuum of approximately 10⁻³ Pa, and a Co metal magnetic film was formed on the non-magnetic substrate 1 by the continuous oblique-angled vacuum evaporation process, while respectively controlling the travel speed of the non-magnetic substrate 1 and the amount of introduced oxygen from sample to sample as listed in Table 1 below.

TABLE 1

| | Travel speed of | Amount of |
|---|---|---|
| | non-magnetic | introduced oxygen |
| | substrate during | during vacuum |
| | vacuum evaporation | evaporation |
| Sample | (m/min) | (liter/min) |
| Comparative | 230 | 4.0 |
| Example 1 | | |
| Example 1 | | 4.3 |
| Example 2 | | 4.5 |
| Example 3 | | 4.7 |
| Example 4 | | 5.0 |
| Comparative | | 5.3 |
| Example 2 | | |
| Comparative | 180 | 3.5 |
| Example 3 | | |
| Example 5 | | 3.8 |
| Example 6 | | 4.3 |
| Example 7 | | 4.5 |
| Example 8 | | 4.7 |
| Comparative | | 5.0 |
| Example 4 | | |
| Comparative | 130 | 2.7 |
| Example 5 | | |
| Example 9 | | 3.0 |
| Example 10 | | 3.2 |
| Example 11 | | 3.5 |
| Comparative | | 4.7 |
| Example 6 | | |
| Comparative | 80 | 2.5 |
| Example 7 | | |
| Comparative | | 2.7 |
| Example 8 | | |
| Comparative | | 3.0 |
| Example 9 | | |
| Comparative | | 3.2 |
| Example 10 | | |
| Comparative | | 4.5 |
| Example 11 | | |

Incident angle of vacuum evaporation was adjusted to 80° to 45° away from the normal line on the non-magnetic substrate, and the magnetic layer of 50 nm thick was formed on the cooling can 6 which was cooled at −40° C. Because the travel speed of the non-magnetic substrate 1 exceeding 230 m/min will destabilize the travel due to limitation in performance of the apparatus, so that no experiment was made under the speed any faster.

Next, the protective layer 23 was formed on the magnetic layer using the CVD apparatus shown in FIG. 4. The protective layer 23 composed of a carbon film was formed to a thickness of 10 nm by using ethylene gas (C₂H₄) as a source material, setting a mixing ratio of ethylene and argon gases of 4:1, and setting a voltage of the reaction tube of DC 1.6 kV.

Next, on the main surface opposite to that having the magnetic layer 22 formed thereon, the back-coat layer 24 was formed by coating a coating material having a composition shown below:

(Coating material for forming back-coat layer)

| | |
|---|---|
| Carbon black | 100 parts by weight |
| (product of Asahi Carbon Co., Ltd. #50) | |
| Polyester polyurethane | 100 parts by weight |
| (product of Nippon Polyurethane Industry Co., Ltd., | |
| trade name N-2304) | |

Solvent:

| | |
|---|---|
| Methyl ethyl ketone | 500 parts by weight |
| Toluene | 500 parts by weight |

After the back-coat layer 24 is formed, annealing for correcting warping (cupping) of the tape, that is hot rolling, is carried out using the hot rolling apparatus 60 shown in FIG. 5. The heat roll 64 was configured as a metal cylindrical roll of approximately 250 mm in diameter, having heating means such as an induction heating coil or the like incorporated therein, and was controlled to 100° C. to 300° C. or around.

After the hot rolling as described in the above, a lubricant composed of perfluoropolyether was coated on the topmost layer to a thickness of approximately 10 nm, to thereby form a lubricant layer.

[Evaluation]

Thus-fabricated master roll of the magnetic tape was slit in an 8-mm width to thereby produce sample tapes, housed in an AIT cassette bodies, and subjected to measurement of magnetic properties by VSM. Film formation conditions, and measurement results of the coercive force H, the square ratio Rs and the error rate of the individual sample magnetic tapes were shown in Table 2. In Table 2, the travel speed of the non-magnetic substrate during the vacuum evaporation already described in Table 1 was also shown.

TABLE 2

| | Travel | | | | |
|---|---|---|---|---|---|
| | speed of | | | | |
| | non- | | | | |
| | magnetic | Amount of | | | |
| | substrate | introduced | | | |
| | during | oxygen | | | |
| | vacuum | during | | | |
| | evapora- | vacuum | Coercive | Square | AIT4 |
| | tion | evaporation | force Hc | ratio | error |
| Sample | (m/min) | (liter/min) | (kA/m) | Rs | rate |
| Comparative | 230 | 4.0 | 110 | 0.75 | 2.5 × 10⁻⁴ |
| Example 1 | | | | | |
| Example 1 | | 4.3 | 133 | 0.77 | 4.3 × 10⁻⁵ |
| Example 2 | | 4.5 | 158 | 0.79 | 2.2 × 10⁻⁵ |
| Example 3 | | 4.7 | 192 | 0.82 | 1.8 × 10⁻⁵ |
| Example 4 | | 5.0 | 221 | 0.84 | 2.6 × 10⁻⁵ |
| Comparative | | 5.3 | 238 | 0.85 | 1.6 × 10⁻⁴ |
| Example 2 | | | | | |
| Comparative | 180 | 3.5 | 115 | 0.72 | 3.0 × 10⁻⁴ |
| Example 3 | | | | | |
| Example 5 | | 3.8 | 145 | 0.74 | 5.2 × 10⁻⁵ |
| Example 6 | | 4.3 | 168 | 0.76 | 3.1 × 10⁻⁵ |
| Example 7 | | 4.5 | 207 | 0.79 | 2.9 × 10⁻⁵ |
| Example 8 | | 4.7 | 229 | 0.80 | 9.0 × 10⁻⁵ |
| Comparative | | 5.0 | 245 | 0.81 | 4.0 × 10⁻⁴ |
| Example 4 | | | | | |
| Comparative | 130 | 2.7 | 124 | 0.66 | 3.5 × 10⁻⁴ |
| Example 5 | | | | | |
| Example 9 | | 3.0 | 152 | 0.69 | 8.9 × 10⁻⁵ |
| Example 10 | | 3.2 | 177 | 0.72 | 5.0 × 10⁻⁵ |
| Example 11 | | 3.5 | 215 | 0.76 | 5.5 × 10⁻⁵ |
| Comparative | | 4.7 | 240 | 0.78 | 2.0 × 10⁻⁴ |
| Example 6 | | | | | |
| Comparative | 80 | 2.5 | 125 | 0.60 | 5.2 × 10⁻⁴ |
| Example 7 | | | | | |
| Comparative | | 2.7 | 154 | 0.64 | 1.7 × 10⁻⁴ |
| Example 8 | | | | | |
| Comparative | | 3.0 | 187 | 0.67 | 1.3 × 10⁻⁴ |
| Example 9 | | | | | |
| Comparative | | 3.2 | 216 | 0.68 | 1.4 × 10⁻⁴ |
| Example 10 | | | | | |
| Comparative | | 4.5 | 238 | 0.72 | 3.5 × 10⁻⁴ |
| Example 11 | | | | | |

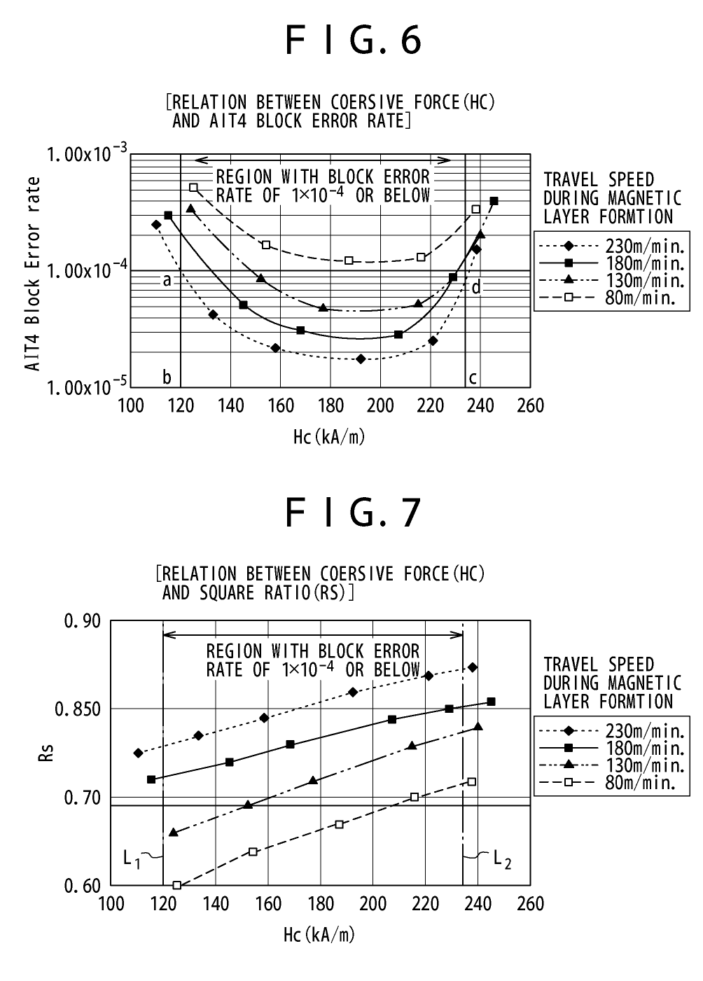

Relations between the coercive force Hc and the error rate of the individual sample magnetic tapes listed in Table 2 were shown in FIG. 6, as being classified by travel speeds during the film formation (80, 130, 180 and 230 m/min). In FIG. 6, the abscissa plots the coercive force Hc measured by VSM, and the ordinate plots the block error rate in AIT4. It is practically necessary in the AIT4 format to suppress the block error rate to 1×10⁻⁴ or below, and this condition was found to be satisfied by the samples obtained under the travel speed of the non-magnetic substrate 1 during the vacuum evaporation of 130 m/min to 230 m/min, which is faster than the conventional travel speed during the vacuum evaporation (80 m/min), and having a coercive force Hc of 120 kA/m to 235 kA/m, that are eleven samples (corresponded to Examples 1 to 11) fall in an area surrounded by points “a” to “d” in FIG. 6.

Next, relations between the coercive force Hc and square ratio Rs of the individual sample magnetic tapes listed in Table 2 were shown in FIG. 7. The abscissa plots the coercive force Hc measured by VSM, and the ordinate plots the square ratio Rs. In FIG. 7, dashed lines L₁ and L₂ indicate the lower limit (120 kA/m) and upper limit (235 kA/m) of the coercive force Hc selected in FIG. 6.

The eleven samples in the area surrounded by the points “a” to “d” in FIG. 6, whose block error rates are 1×10⁻⁴ or below, fall in an area of the square ratio Rs being 0.69 or above in FIG. 7.

As is obvious from the above, the block error rate (1×10⁻⁴ or below) necessary for the AIT4 format was successfully achieved by carrying out the high-rate vacuum evaporation while setting the travel speed of the non-magnetic substrate to as fast as 130 m/min or above, and by specifying coercive force Hc as 120 kA/m to 235 kA/m, and square ratio Rs as 0.69 or above.

What is claimed is:

1. A method of fabricating a magnetic recording medium comprising a step of allowing a non-magnetic substrate to continuously travel and forming a magnetic layer by a vacuum evaporation process under introduction of an oxygen gas, wherein:
a travel speed of said non-magnetic substrate is adjusted to 130 m/min to 230 m/min, and
a coercive force Hc of said magnetic layer is adjusted to 120 kA/m to 235 kA/m and a square ratio Rs thereof is adjusted to 0.69 or above.
